(19) United States
(12) Patent Application Publication
(10) Pub. No.: US 2003/0159850 A1
(43) Pub. Date: Aug. 28, 2003

(54) Modular electrical connector system

(76) Inventor: David G. McCarthy, Huntington, CT (US)

Correspondence Address: Mark P. Stone, Suite 205, 1100 High Ridge Road, Stamford, CT, 06905, US

(21) Appl. No.: 10/085,502

(22) Filed: Feb. 27, 2002

(51) Int. Cl. H01R 4/60

(52) U.S. Cl. 174/211; 439/211

(57) ABSTRACT

A modular electrical power block assembly includes four ports for receiving up to four individual circuit modules to simultaneously provide up to four separate electrical circuits. The four electrical circuits are formed from eight separate conductors arranged such that each electrical circuit has a separate live conductor, two of the electrical circuits have a first common neutral and a first common ground conductor, and two of the electrical circuits have a second common neutral and a second common ground conductor. The individual circuit modules are selectively removable and insertable into the four ports to complete one or more of the four electrical circuits, at the selection of the user.

### BACKGROUND OF THE INVENTION

The present invention is directed to electrical connector systems including modular power blocks defining ports for removably receiving individual circuit modules for selectively completing one or more predetermined electrical circuits.

The present Applicant owns U.S. Pat. No. 4,775,328, issued on Oct. 4, 1988, and U.S. Pat. No. 5,755,583, issued on May 26, 1998. These patents disclose modular electrical power block assemblies of the general type to which the subject matter of the present application is directed. The disclosures of U.S. Pat. Nos. 4,775,328 and 5,755,583 are expressly incorporated by reference in the present patent application.

Known electrical distribution systems are disclosed by the prior art discussed and cited of record in connection with Applicant's aforementioned prior U.S. patents. A publication entitled “Electri-Pak Systems”, Copyright 1992, published by Electri-Cable Assemblies, Inc. discloses an eight wire modular electrical connector system providing both three and four separate electrical circuits. A similar publication entitled “Electri-Pak 8”, Copyright 1991, published by Electri-Cable Assemblies, Inc., discloses an eight wire power block for providing either three or four circuits for an electrical connector system. The power blocks disclosed in each of the aforementioned publications are limited to three ports on each side of the power block, and are therefore not capable of providing four different electrical circuits simultaneously.

Other known electrical distribution systems are exemplified by U.S. Pat. Nos. 3,854,001 (Dola); 4,255,610 (Textoris); 4,278,834 (Boundy); 4,433,630 (Laborie); and 4,557,177 (Cheney), each of which were cited of record in connection with Applicant's prior U.S. Pat. No. 4,775,328. U.S. Pat. Nos. 4,165,443 (Figart); 4,386,333 (Dillan); and U.S. Pat. No. 3,922,478 (Perkey); each of which are discussed as background information in the specification of Applicant's prior U.S. Pat. No. 4,775,328, are also illustrative of known electrical distribution systems. Further examples of known electrical distribution systems are disclosed in U.S. Pat. Nos. 4,313,646 (Millhimes et al); 5,046,963 (Kelly) and 5,092,787 (Wise et al), each of which were cited of record in connection with Applicant's prior U.S. Pat. No. 5,755,583.

It is the primary object of the present invention to provide an improved modular electrical power block assembly for use in connection with an improved electrical distribution system.

### SUMMARY OF THE INVENTION

An electrical connector and power distribution system includes a modular electrical power block defining at least four ports for removably receiving up to at least four electrical circuit modules for simultaneously completing up to at least four separate electrical circuits at the selection of the user. Preferably, each side of the power block includes four separate ports, each of the ports adapted to removably receive a separate circuit module to complete a different predetermined electrical circuit. Therefore, at the selection of the user, one, two, three, or four separate and different electrical circuits simultaneously can be provided on each side of the power block assembly by inserting the appropriate number of circuit modules in the appropriate corresponding ports. Preferably, the four different electrical circuits of the power block are provided by eight separate electrical conductors arranged such that two of the electrical circuits are formed from two separate live conductors, a first shared common ground conductor, and a first shared common neutral conductor, while the remaining two electrical circuits are formed from two separate live conductors, a second shared common ground conductor, and a second shared common neutral conductor. In an alternative arrangement of circuitry, the four electrical circuits are provided by eight conductors arranged such that a first circuit is formed from a separate live conductor, a separate ground conductor, and a separate neutral conductor, while the remaining three circuits are formed from three separate live conductors, one common ground conductor shared by the remaining three circuits, and one common neutral conductor shared by the remaining three circuits. In this later arrangement, at least one of the four circuits has separate live, ground and neutral conductors which are not shared by any of the remaining three circuits.

### BRIEF DESCRIPTION OF THE DRAWINGS

FIG. 1 illustrates a first power block assembly in accordance with the present invention;

FIG. 2 is a schematic diagram of the electrical circuitry provided by the power block illustrated by FIG. 1;

FIG. 3 illustrates a second power block in accordance with the present invention; and

FIG. 4 is a schematic diagram of the electrical circuitry provided by the power block illustrated by FIG. 3.

### DESCRIPTION OF THE BEST MODES FOR CARRYING OUT THE INVENTION

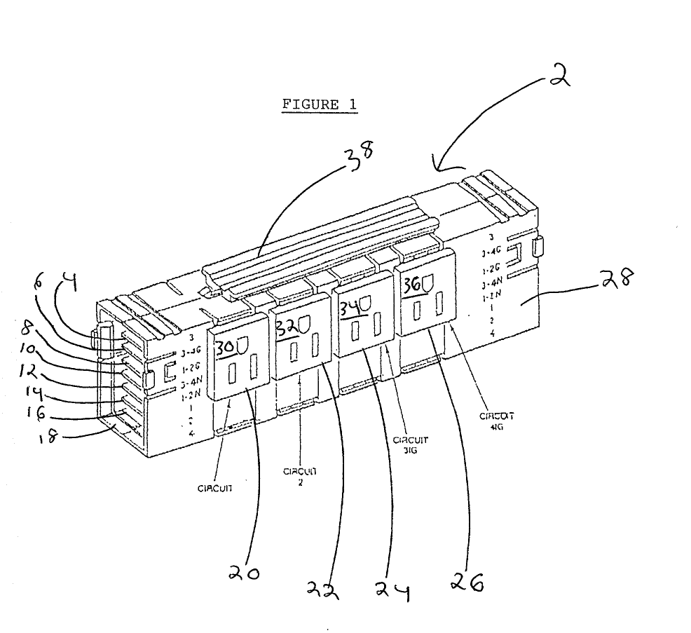

FIGS. 1-4 of the drawings illustrate the preferred embodiments of the improved electrical power block assembly and distribution system, in accordance with the present invention.

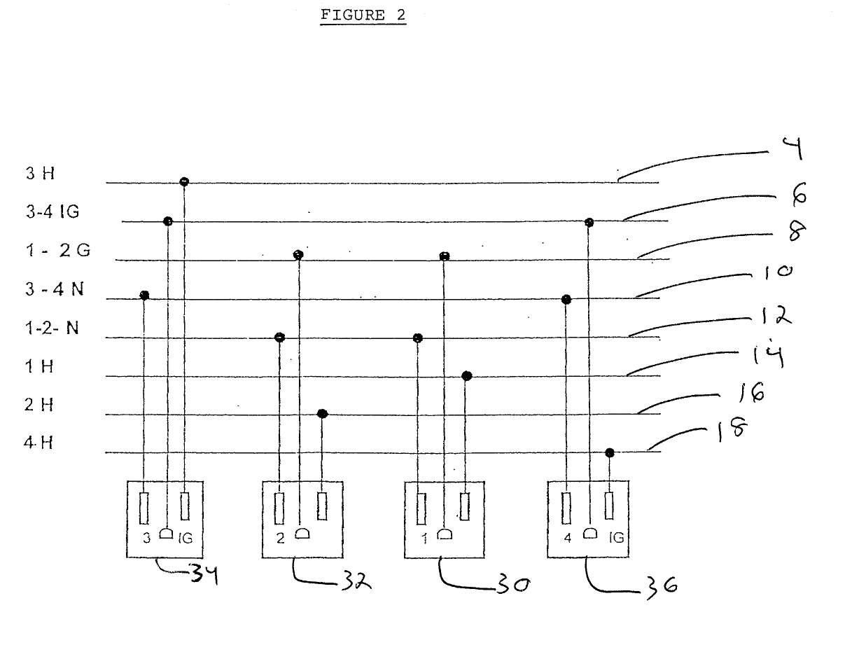

FIG. 1 is a perspective view of a first embodiment of a power block housing, and FIG. 2 schematically illustrates the electrical conductors extending through the power block. The power block housing, generally designated by reference numeral 2, includes eight parallel electrical conductors extending therethrough in a longitudinal direction. The conductors are arranged sequentially, from top to bottom in the power block, in the following order: a first live conductor 4 is arranged above a first common ground conductor 6, which is arranged above a second common ground conductor 8, which is arranged above a first common neutral 10, which is arranged above a second common neutral 12, which is arranged above a second live conductor 14, which is arranged above a third live conductor 16, which is arranged above a fourth live conductor 18. The arrangement and orientation of the eight live conductors extending through the power block 2 of FIG. 1 is best illustrated by the schematic diagram of FIG. 2.

Power block 2 defines four separate ports 20, 22, 24, 26, on a first (front) surface of the power block designated by reference numeral 28. The respective ports are shown in the drawing to be accommodating different circuit modules removably received therein. The circuit modules are designated, respectively, by reference numerals 30, 32, 34 and 36. Each circuit module defines three openings on the outer facing surface thereof for receiving the prongs of an electrical plug.

Although not illustrated by FIG. 1, the opposed (rear) surface of the power block 2 can be the mirror image of the front surface 28, defining four additional ports 20, 22, 24, and 26 for removably receiving therein up to four additional circuit modules 30, 32, 34, and 36 for providing access to the four different electrical circuits from the rear surface of the power block. Reference numeral 38 illustrates a mounting bracket provided on the top of the power block 2.

The individual circuit modules 30, 32, 34, and 36 are selectively inserted into and removed from the respective ports 20, 22, 24, and 26 in the same manner disclosed in U.S. Pat. No. 4,775,328, using the same tool disclosed in U.S. Pat. No. 4,775,328. As noted, the disclosure of U.S. Pat. No. 4,775,328 is expressly incorporated by reference herein. As also disclosed in U.S. Pat. No. 4,775,328, each of the circuit modules includes three conductive prongs on the rear surface thereof for engaging three different electrical conductors running through the power block to complete a predetermined electrical circuit. The three prongs on each of the different circuit modules 30, 32, 34 and 36 are oriented to engage different conductors to complete four different circuits, as best illustrated by the schematic diagram of FIG. 2. Therefore, the power block 2 is capable of simultaneously providing as many as four different electrical circuits, at the selection of the user, dependent upon the number of circuit modules 20, 22, 24, and 26 inserted into the ports 30, 32, 34 and 36. Thus, the power block 2 provides, at the selection of the user, one, two, three or four different electrical circuits simultaneously, and permits the user to vary the number of electrical circuits by varying the number of circuit modules removably inserted into the ports.

FIG. 2 is a schematic diagram illustrating the arrangement of the eight electrical conductors extending through the power block 2, and the engagement of the electrical conductors by the circuit modules received in the ports of the power block. Circuit module 30, when received in port 20, engages electrical conductors 14, 12, and 8 to define a first predetermined electrical circuit formed from a single live electrical conductor, a first shared neutral electrical conductor, and a first shared ground electrical conductor. Circuit module 32, when received in port 22, engages electrical conductors 8, 12, and 16 to define a second predetermined electrical circuit formed from a separate live electrical conductor, a first shared neutral electrical conductor, and a first shared ground electrical conductor. Electrical circuit module 34, when received in port 24, engages electrical conductors 4, 6, and 10 to define a third predetermined electrical circuit formed from a single live conductor, a second shared neutral electrical conductor, and a second shared ground electrical conductor. Electrical circuit module 36, when received in port 26, engages electrical conductors 6, 10, and 18 to define a fourth predetermined electrical circuit formed from a separate live electrical conductor, a second shared neutral electrical conductor, and a second shared ground electrical conductor. Accordingly, any or all of the four different predetermined electrical circuits can be provided simultaneously, at the selection of the user, by removably inserting one or more of the circuit modules 30, 32, 34 and 36 into the ports provided on the power block 2.

Although the drawing illustrates that each of the circuit modules 30, 32, 34 and 36 is inserted into a specific port defined on the front surface 28 of the power block 2, any of the circuit modules can be inserted into any of the ports and will provide the same predetermined circuit. This occurs because the individual circuit modules are arranged to engage only three specific conductors extending through the power block 2 regardless of the specific port into which the circuit module is inserted. Therefore, for example, circuit module 30 can be inserted into any of the ports 20, 22, 24 and 26, and will still provide only the same first predetermined circuit since circuit module 30 is designed to engage only electrical conductors 8, 12 and 14 without regard to the specific port in which it is received. Since any of the circuit modules 30, 32, 34 and 36 can be removably received in any of the ports, 20, 22, 24 and 26, each of the circuit modules is marked to identify the specific circuit provided by that module, as illustrated by FIG. 2.

As also previously indicated, four additional ports 20, 22, 24, and 26 can be defined on an opposed (rear) surface of the power module 2 for accommodating four additional circuit modules 30, 32, 34 and 36 to provide the first, second, third and fourth electrical circuits accessible from the rear surface of the power module. The arrangement, configuration and relationship between the electrical conductors, the circuit modules and the ports defined on the rear surface of the power block 2 are identical to that discussed herein with respect to the ports and circuit modules on the front surface 28 of the power block 2.

As shown by FIG. 1, a portion of the outer surface of the power block 2 is marked to designate the identity, location and arrangement of the specific different electrical conductors extending through the power block.

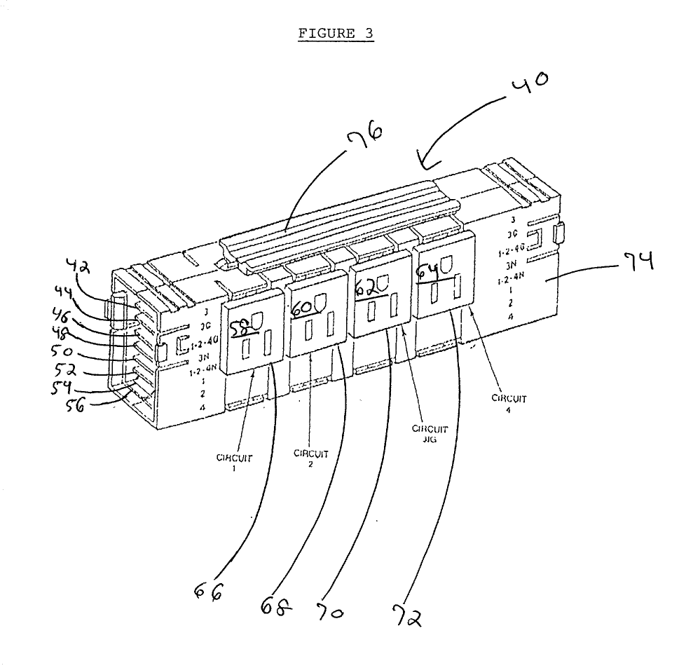

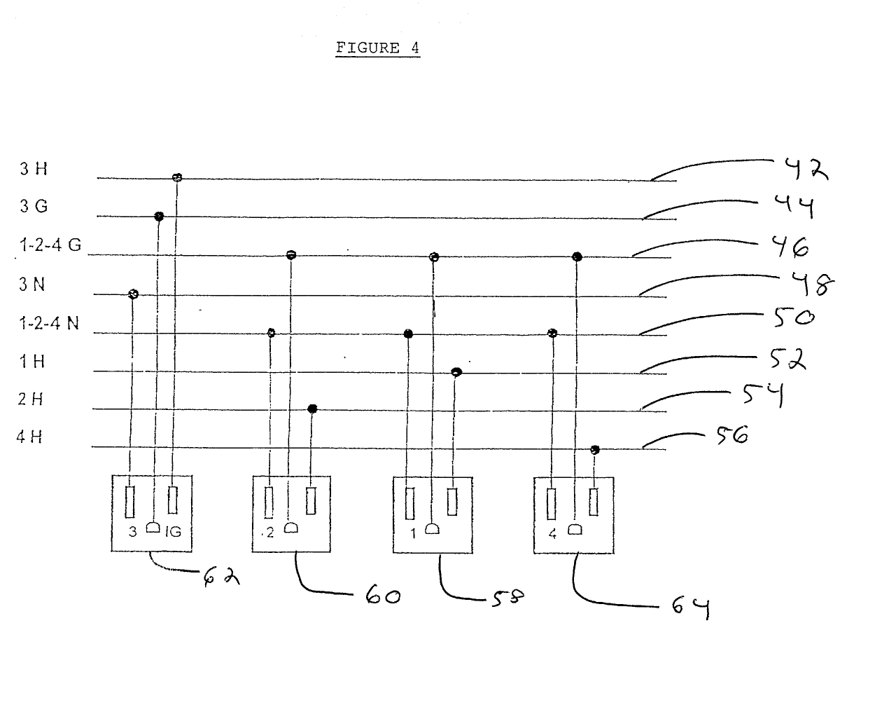

Turning now to FIGS. 3 and 4 of the drawing, FIG. 3 illustrates a second power block generally designated by reference numeral 40. Except for the different arrangement of electrical conductors extending through power block 40, power block 40 is physically identical to power block 2 illustrated by FIG. 1 and previously discussed herein. Accordingly, the prior discussion of the power block illustrated by FIG. 1, and the structural relationship between that power block and the circuit modules, ports, and electrical conductors (except for the specific arrangement of electrical conductors), is equally applicable to the embodiment of the invention illustrated by FIG. 3.

In FIG. 3, eight parallel electrical conductors 42, 44, 46, 48, 50, 52, 54 and 56 extend longitudinally through the power block 40. Four circuits modules 58, 60, 62 and 64 are shown removably received in four respective ports 66, 68, 70 and 72, each of which are defined on a front surface 74 of the power block 40. A mounting bracket 76 extends from the top surface of the power block.

As discussed with respect to FIG. 1, the circuit modules 58, 60, 62 and 64 each engage three specific electrical conductors when the module is received in a port to define a different predetermined electrical circuit. Therefore, at the selection of the user, one, two, three, or four of the different predetermined electrical circuits simultaneously can be provided by removably inserting one, two, three, or four of the different circuit modules in the ports of the power block. As discussed with FIG. 1, any of the circuit modules 58, 60, 62 and 64 can be inserted into any of the ports 66, 68, 70 and 72, and will provide the same predetermined electrical circuit. As also discussed with respect to FIG. 1, power block 40 can define four additional ports on a rear surface thereof for removably receiving therein additional circuit modules 58, 60, 62 and 64 to provide access to one, two, three, or four of the different predetermined electrical circuits, at the selection of the user, on the rear surface of the power block.

FIG. 4 illustrates the four different predetermined electrical circuits provided by circuit modules 58, 60, 62 and 64 when they are removably received in the ports of the power block 40. Circuit module 58, when received in port 66 of the power block 40, engages electrical conductors 46, 50 and 52 to define a first predetermined electrical circuit formed from a live electrical conductor, a shared netural electrical conductor, and a shared ground electrical conductor. Circuit module 60, when received in port 68 of the power block 40, engages electrical conductors 46, 50, and 54 to define a second predetermined electrical circuit formed from a separate live electrical conductor, a shared neutral electrical conductor, and a shared ground electrical conductor. Circuit module 62, when received in port 70 of power block 40, engages electrical conductors 42, 44, and 48 to define a third predetermined electrical circuit formed from a separate live electrical conductor, a separate ground electrical conductor, and a separate neutral electrical conductor. Circuit module 64, when received in port 72 of the power block 40, engages electrical conductors 46, 50, and 56 to define a fourth predetermined electrical circuit formed from a separate live electrical conductor, a shared neutral electrical conductor, and a shared ground electrical conductor. Accordingly, circuit module 62, when received in any port of the power block 40, provides a predetermined electrical circuit having separate live, neutral and ground electrical conductors, while circuit modules 58, 60 and 64 define different predetermined electrical circuits, each of which share the same neutral and ground electrical conductors.

As discussed with respect to power block 2 illustrated by FIG. 1, the identity, location and arrangement of the eight parallel electrical conductors extending longitudinally through the power block 40, are marked on a portion of the outer surface of the power block itself. The circuit modules 58, 60, 62, and 64 are each marked to identify the different predetermined circuit completed by the circuit module when received in a port of the power block, and each of the circuit modules includes three openings on the outer facing surface thereof for receiving the prongs of an electrical plug. As also discussed with respect to FIG. 1, each respective circuit module 58, 60, 62 and 64 will complete the same respective predetermined electrical circuit without regard to the specific port of the power block 40 in which the circuit module is removably received.

The electrical conductors extending through the power block 2 (FIG. 1) and the power block 40 (FIG. 3) are adapted to be coupled to a source of electrical power, as illustrated and disclosed in previously issued U.S. Pat. No. 4,775,328.

The preferred embodiments of the invention disclosed herein provide electrical connector and distribution systems capable of providing up to four different electrical circuits simultaneously, at the selection of the user. It is also within the scope of the present invention to provide more than four different electrical circuits simultaneously, which can be accomplished by increasing the number of available ports in the power block, increasing the number of live electrical conductors to correspond to the maximum numbers of electrical circuits that the system is capable of providing, and providing additional circuit modules for engaging the added live electrical conductors to define the additional electrical circuits.

Other modifications and advantages of the systems disclosed herein within the scope of the present invention will become apparent to those skilled in the art. Accordingly, the description of the preferred embodiments herein is intended to be illustrative only, and not restrictive of the scope of the invention, that scope being defined by the following claims and all equivalents thereto.

1. A modular electrical power system comprising:
a housing having a plurality of electrical conductors extending therethrough;
said housing defining at least four ports therein;
at least four circuit modules removably receivable in said ports of said housing;
each of said circuit modules adapted to engage a different combination of said electrical conductors in said housing for defining a different predetermined electrical circuit;
wherein said modular power system simultaneously provides, at the selection of the user, one, two, three or four of said different predetermined electrical circuits.

2. The system as claimed in claim 1, wherein each of said circuit modules is removably receivable in any one of said ports defined in said housing.

3. The system as claimed in claim 1, wherein said plurality of electrical conductors extending through said housing comprises at least eight electrical conductors.

4. The system as claimed in claim 3 wherein said at least eight electrical conductors comprise at least four live electrical conductors, two neutral electrical conductors, and two ground electrical conductors.

5. The system as claimed in claim 4 wherein two of said four predetermined electrical circuits are each formed from a different one of said live electrical conductors, a first neutral conductor shared by said two predetermined electrical circuits, and a first ground conductor shared by said two predetermined electrical circuits.

6. The system as claimed in claim 5 wherein two other of said four predetermined electrical circuits are each formed from a different one of said live electrical conductors, a second neutral conductor shared by said two other predetermined electrical circuits, and a second ground conductor shared by said two other predetermined electrical circuits.

7. The system as claimed in claim 4 wherein said at least eight electrical conductors extend longitudinally through said housing.

8. The system as claimed in claim 4, wherein said at least eight electrical conductors are arranged sequentially in said housing, from top to bottom, as follows:
a first live conductor, one of said ground conductors, another of said ground conductors, one of said neutral conductors, another of said neutral conductors, a second live conductor, a third live conductor, and a fourth live conductor.

9. The system as claimed in claim 4 wherein said eight electrical conductors are arranged in said housing such that one of said live electrical conductors is separated from each of said other three live electrical conductors by at least four of said other electrical conductors.

10. The system as claimed in claim 4 wherein at least one of said four predetermined electrical circuits is formed from a first one of said live conductors, a first said ground conductor, and a first said neutral conductor.

11. The system as claimed in claim 10 wherein each of said other three predetermined electrical circuits is formed from a different one of said live electrical conductors, a second said ground conductor shared by said other three predetermined electrical circuits, and a second said neutral conductor shared by said other three predetermined electrical circuits.

12. A modular electrical power system comprising:
a housing having a plurality of electrical conductors extending therethrough;
said housing defining at least four ports therein, each of said ports adapted to removably receive a circuit module defining a different predetermined electrical circuit such that said power system is capable of simultaneously providing, at the selection of the user, a maximum of at least four different predetermined electrical circuits;
said plurality of electrical conductors comprising at least four live conductors, two neutral conductors, and two ground conductors.

13. The system as claimed in claim 12 wherein said plurality of electrical conductors are arranged in said power block such that two of said different predetermined electrical circuits are each formed by a different one of said live electrical conductors, a first said ground electrical conductor shared by said two predetermined electrical circuits, and a first said neutral electrical conductor shared by said two predetermined electrical circuits.

14. The system as claimed in claim 13 wherein two other of said predetermined electrical circuits are each formed by two different said live electrical conductors, a second said ground conductor shared by said two other predetermined electrical circuits, and a second said neutral conductor shared by said two other predetermined electrical circuits.

15. The system as claimed in claim 12 where one of said different predetermined electrical circuits is formed from one of said live electrical conductors, a first said neutral electrical conductor, and a first said ground electrical conductor.

16. The system as claimed in claim 15 wherein three other of said different predetermined electrical circuits are each formed from a different one of said live electrical conductors, a second said ground electrical conductor shared by said three other predetermined electrical circuits, and a second said neutral electrical conductor shared by said three other predetermined electrical circuits.

17. A modular electrical power system comprising:
a housing having at least eight electrical conductors extending therethrough;
said eight electrical conductors comprising four live electrical conductors, two neutral electrical conductors, and two ground electrical conductors;
said electrical conductors adapted to define at least four different predetermined electrical circuits;
two of said predetermined electrical circuits each being formed from a different one of said live electrical conductors, a first said ground conductor shared by said two predetermined electrical circuits, and a first said neutral conductor shared by said two predetermined electrical circuits;
two other of said predetermined electrical circuits each being formed from a different one of said live electrical conductors, a second said ground conductor shared by said two other predetermined electrical circuits, and a second said neutral conductor shared by said two other predetermined electrical circuits;
said housing defining at least one port for removably receiving at least one circuit module for defining at least one of said four different predetermined electrical circuits.

18. The system as claimed in claim 17 wherein said housing defines a plurality of ports.

19. The system as claimed in claim 18 further including a plurality of circuit modules removably receivable in said plurality of ports for simultaneously providing, at the selection of a user, a plurality of said different predetermined electrical circuits.

20. The system as claimed in claim 19 wherein each of said plurality of circuit modules is removably receivable in any one of said plurality of ports.
